(19) United States
(12) Patent Application Publication
(10) Pub. No.: US 2024/0014773 A1
(43) Pub. Date: Jan. 11, 2024

(54) Curtain Wall with Built-In Solar Photovoltaic

(71) Applicant: Oren Aharon, Haifa (IL)

(72) Inventor: Oren Aharon, Haifa (IL)

(21) Appl. No.: 17/858,139

(22) Filed: Jul. 6, 2022

(51) Int. Cl. H02S 20/26

(52) U.S. Cl. CPC H02S 20/26; E04B 2/88

(57) ABSTRACT

High-rise glass buildings are characterized by a high ratio between envelope area and roof area. The roof area is limited and usually populated with various gears; however, the envelope area is large and pristine. It is the purpose of the disclosed patent to populate the non-vision areas within the building with solar panels incorporated into the glazing shield to provide isolation, solar electricity and heat in wintertime. Using double-skin curtain wall with front solar PV will cause excessive heat in the cavity between the two panels, caused by heat absorption of solar panel without ventilation. Our challenge is to dissipate the heat, controlling the temperature of said cavity. The main obstacle of incorporating regular solar panels within the glazing envelope is the fact that the sun density on a vertical assembly is only 70% compared to regular PV, therefore adding heat harvesting can offset this problem significantly.

### BACKGROUND OF THE INVENTION

### 1. Field of Invention

The building industry is responsible for about 45% of energy consumption and carbon emissions all over the world. Many governments have promised to reduce greenhouse emission. The building sector will be the first candidate for greenhouse emissions reduction, especially glass buildings and their envelopes which proves to be very ineffective and creates a greenhouse effect in the building's interior. The present invention relates to a PV system incorporated into the non-vision area of building, which currently account for 35% of envelope area in high-rise glass buildings. Furthermore, the proposed system will create shading within the building in the non-vision areas and will generate heat in those areas at wintertime. In fact, this will have a considerable impact on buildings' total energy consumption, since the building is interconnected and its temperature is controlled by central air conditioning.

### 2. Description of the Related Art

The building integration of photovoltaics is attracting more and more worldwide attention where PV specialists and innovative design are exploring new ways of integrating advanced systems in the building process. However, there are many obstacles in incorporating this technology in glass buildings, since it creates a large non-vision area inside the building and it's not architecturally attractive. By replacing glass curtain wall into the non-vision (spandrel) area of the building, a multi-function active adaptation of the spandrel to environment while harvesting solar energy is advantageous. The disclosed art is actually a logical next step into BIPV (Building Integrated Photo Voltaics) industry, facilitating seamless integration into glass building. A complete BIPV system usually includes:
a) PV modules.
b) Charge Controllers.
c) A power storage system or grid connection to the utility grid.
d) Power conversion equipment.
e) Appropriate installation hardware.

Our disclosed art is related to the PV modules.

In a previous patent U.S. Ser. No. 10/181,816B2, a technology of a triple glazed curtain wall was disclosed with two hermetically sealed cavities and an absorbing plane in between to harvest the solar heat and using fans for air circulation in each cavity. This solution which is based on two cavities turned out to be very expensive, due to the complications of triple glazing and special assembly of built-in air fans. It is the purpose of disclosed art to offer a double-glazed single cavity solution based on current manufacturing. The technology is based on an externally mounted kit on top of existing double-glazed technology. The device will harvest solar energy and expel excessive heat generated by the solar PV to the exterior or interior, depending on building needs.

### SUMMARY

Due to the growing urbanization, high-rise buildings are a perfect solution, incorporating immaculate aesthetics while practicality allowing many people to populate a relatively small area without being overcrowded. However, due to the lack of awareness to energy problems, most of those buildings are very inefficient, and once installed, those curtain walls are passive and do not harvest the solar energy inundating their facades. Actually, this solar inundation is frequently regarded as nuisance since it heats the building and creates a greenhouse effect. The disclosed art will partially solve the problem by taking advantage of a significant portion of the excessive solar energy and transfer it to electricity. Moreover, using built-in heat exchangers into the double-curtain wall, accumulated heat within the curtain wall will be used during wintertime for building needs. Heat management in said PV curtain wall will be achieved by a smart built-in directional heat dissipation system.

Curtain wall and photovoltaics pose significant problems when integrating the solar panel into the curtain wall, since by definition a curtain wall is designed for visual transparency, however the solar panel is opaque. The areas on building facades where opaqueness is acceptable are called spandrels, and they are usually about 35% of façade area. The building isolation provided by the curtain wall will create a special challenge when incorporating solar panels, since most of solar energy is transferred into heat causing the isolating hermetically sealed air to expand, which can cause structural damage to the curtain wall. Said heat load created by solar energy will create excessive load on VAC systems since it can overheat the building interior during summertime. It is the purpose of disclosed art to overcome those drawbacks and offer a system which can provide solar energy free of mentioned disadvantages.

To do so, the integrated photovoltaic system will be based on a front photovoltaic panel, an air isolation gap and a second sealing glass or other material panel. The photovoltaic panel side will be installed facing the sun and the glass panel will be facing the building interior. A special area, preferable installed on top of the photovoltaic curtain wall, will be mounted with a compact air heat exchanger. The heat exchanger will dissipate excessive heat, building up in the enclosed hermetically sealed gap between front and back panel. Air circulation will be the driving force for heat removal. Heat removal from said cavity in between the two panels of the isolating curtain wall is performed by circulating the air from said gap into the heat exchangers, exchanging heat from cavity to surroundings. Moreover, the system may have two heat exchangers—one inside the building and second outside the building. Depending on building needs activation of either one of them could be performed independently by activated built-in fans, if needed both heat exchangers could be activated significantly changing the U-value of the curtain wall. A solar panel usually generates about 20% of electricity wherein most of incoming sun radiation is transformed into heat. This heat absorption creates high temperatures on the photovoltaic front panel and it's an engineering obstacle whenever installation other than open space will create a heat load to the isolation gap. By implementing the disclosed art this could be avoided since the proposed device will dissipate unwanted energy encapsulated in the gap to the environment. Dictated by building's needs, a smart dissipation process will be applied, expelling unwanted heat to building's front outside or when needed to the interior, according to temperatures as measured by dedicated sensors. Measurement information and fans activation is controlled by dedicated built-in microcontroller. Furthermore, when needed, parallel fans activation can lower the static R-value to increase heat transfer directly between building and environment, and this can be performed regardless of incident solar radiation.

It is our goal to offer a superior BIPV technology, preferable to be installed into the spandrel areas to generate electricity and heat when needed.

The invention concerns a PV based double glazing module with built-in heat exchangers controlling heat expelling from the isolating gap between the two facets of the curtain wall to direct heat to building interior or exterior as needed.

The presented art innovation is offering a new kind of PV installation into the façade, generating heat and electricity at high levels, offsetting the electrical energy losses due to the fact that installation is vertical. By incorporating smart electronics, the system will work independently using solar energy for its own activation.

An aspect of the present disclosed art is a curtain wall with built-in solar cells and a heat exchanger designed to cool the hermetically sealed cavity between said two panels to avoid excessive temperature levels of curtain wall structure. Other aspects provide means to harvest the heat generated by solar radiation, impinging on PV panels and deliver to building interior, increasing the total solar efficacy of the device. Yet another aspect will be the capability to cool the building during night hours by expelling heat to environment. Curtain wall assembly includes two panels with an air cavity in between, and a heat exchanger preferable on the top of the curtain wall, performing the heat exchange for the whole panel by air fans that will circulate the encapsulated air to the sealed heat exchanger, thus expelling or inhaling heat according to the building needs. Building needs are monitored by a built-in AI microcontroller in charge of performing the necessary fan activation to achieve a predeterminate goal.

To summarize, a solar panel assembly for curtain wall with built-in heat exchanger is disclosed, comprising of a non-structural isolating curtain wall with at least two panels, one of them facing towards the sunlight and has a built-in solar panel, a heat exchanger kit equipped with fans circulating the air in between said panels, an electronic driver to control said fans, batteries drawing their power from said solar panel and harnessing cables to conduct energy from said solar panel to building's electrical infrastructure. The said heat exchanger may be assembled from two heat exchangers, one facing the interior and the second facing the exterior, fan means for each of said heat exchangers, control means activating the fans according to a microcontroller and directing the heat exchanging to interior, to exterior or in a parallel mode.

Other aspects of the present disclosure can be understood by those skilled in the art in light of the description, the claims, and the drawings of the present disclosure.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic representation of prior art curtain wall technology

FIG. 2 is a schematic representation of disclosed art incorporating a solar panel as part of the curtain wall, along with necessary heat exchangers.

FIG. 3 is a cross-section along the center of the cavity enclosed by two panels—one with built-in solar facing the exterior, and the second panel preferable glass, facing the interior, including air flow directions.

FIG. 4 is a cross-section in a perpendicular direction to panels located at the center of the system.

FIG. 5 is a cross-section in a perpendicular direction to panels located at one end of said curtain wall, and it is identical with the opposite end.

### DETAILED DESCRIPTION OF THE DRAWINGS

The following exemplary embodiments of the disclosure will be described with reference to their specific figures. Whenever possible, reference number for same parts will be used through all figures. The figures and their embodiments will allow persons of ordinary skills in the art to deduct different embodiments which are consistent with disclosed figures, and thus protected by the patent. For clarification, the first drawing will be a schematic representation of prior art technology used for curtain walls and lacking solar panels built-in into their assemblies.

However, the disclosed art provides the system and the method for fully integrating a solar panel within the curtain wall and providing hermetically sealed within ventilation for harvesting the solar heat in wintertime and expelling excessive heat to environment to prevent unwanted results and excessive load to the curtain wall, thus preventing its failures. The said ventilation is generated within the curtain wall double glazing, and it's enclosed in the hermetically sealed cavity, and heat is dissipated through sealed heat exchangers preventing air from leaking to the environment.

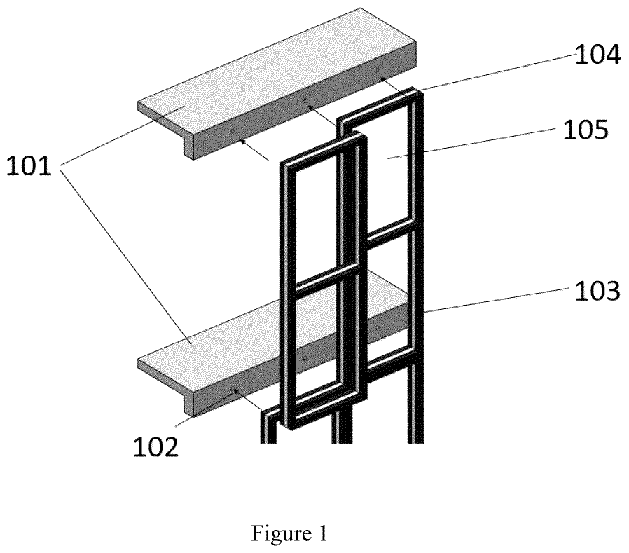

FIG. 1 illustrates a typical assembly of current technology where a double-glazed curtain wall with isolating cavity in between is mounted on building's frame, usually aluminum or steel and denoted by 101. Mounting area for external curtain wall on frame is denoted by 102. 103 is an aluminum enclosing frame for curtain wall glass element. 104 is a separation enclosure enclosing the cavity of the double-glazed curtain wall, this enclosed cavity usually air provides a very effective heat isolation from the environment. 105 is the glass element facing the exterior.

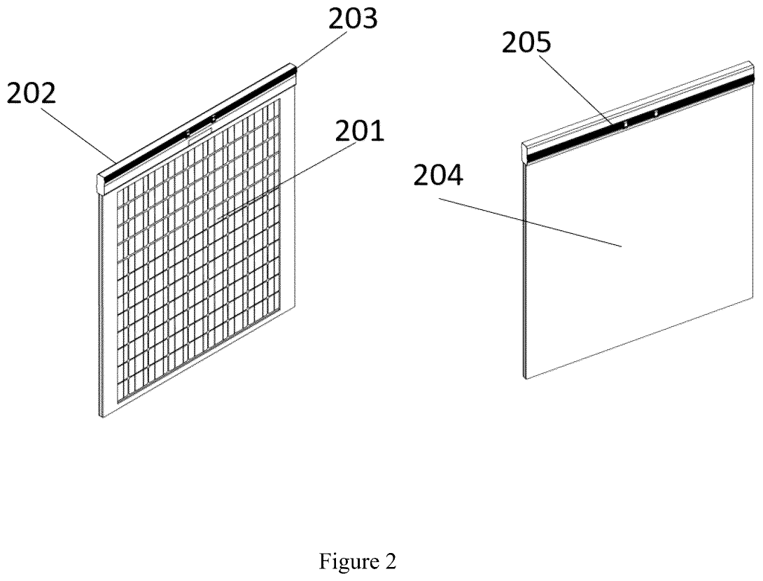

FIG. 2 is an example of proposed technology according to embodiment of present disclosure. The system may include a solar panel 201 mounted on the external glass and facing the sun. 202 is an external kit mounted on top of prior art curtain wall, and has the capability to circulate the air enclosed between the curtain wall's panels through special orifices in the curtain wall separation frame. 203 is a hollow heat exchanger, preferable with circular perimeter designed to dissipate enclosed heat in the curtain wall cavity to the exterior part of glass assembly. 204 is the panel facing the interior, and 205 is the second heat exchanger in the interior designed to dissipate enclosed heat in the curtain wall to buildings inner side.

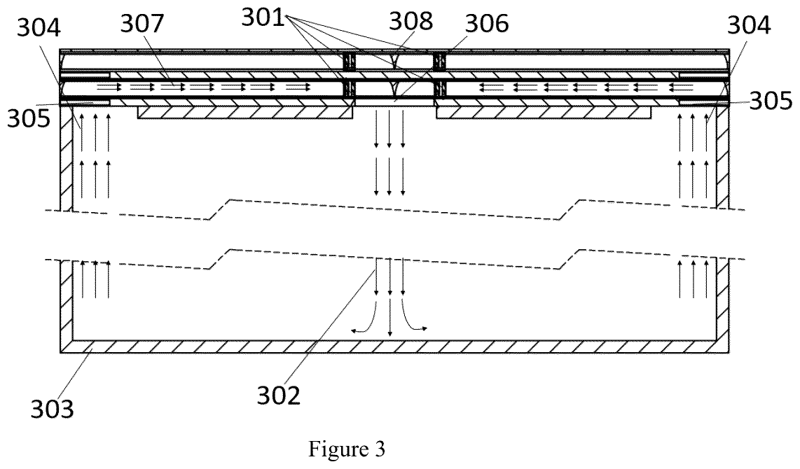

FIG. 3 describes the proposed kit installed on top of a double-glazed curtain wall—this is a longitudinal cross-section showing the main components of proposed kit and their installation procedure. Fans designated as 301 will force air down towards a direction denoted as 302. The airflow hitting the external enclosure of the cavity, denoted as 303, will rebound towards the walls of enclosure and suction along the direction denoted as 304 and will be recycled at the direction of 302 through the openings of said enclosure, denoted as 305. The opening where the air is blown into said cavity is denoted as 306. Air flowing in the direction of 307 will be cooled since it flows in a highly conductive metal like copper and its heat will be dissipated to the environment. For redirection and preventing air mixture between the two directions, a separating 308 will direct flow into the cavity from the fans denoted as 301.

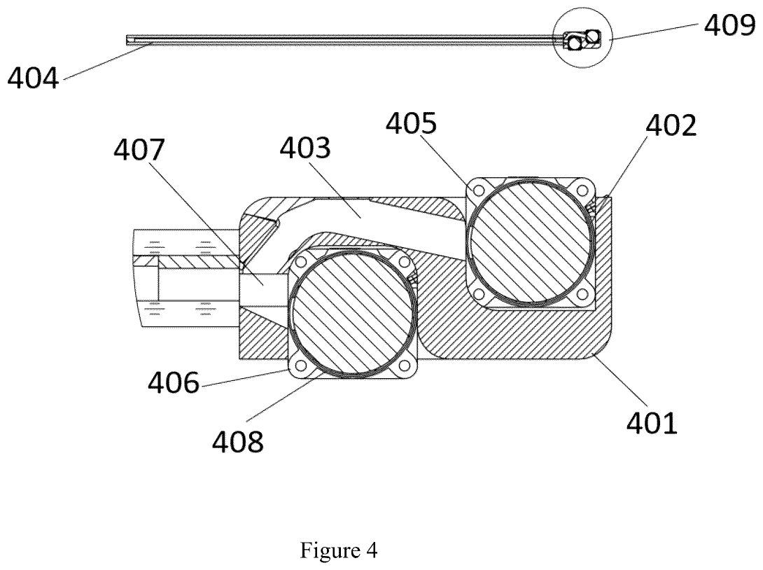

FIG. 4 is yet another cross-section perpendicular to the cross-section disclosed in FIG. 3, primarily showing the heat exchanger pipes and their engineering. The cross section is on the curtain wall center. 401 is an isolating shell and frame for dissipating heat exchangers built as metal corrugated pipes and denoted as 402. This pipe faces the interior. The cavity denoted as 403 will direct airflow into separating air cavity of curtain wall. The curtain wall is denoted as 404. By activating fans 405 mounted on the heat exchanger pipe facing the interior, one can start or stop air circulation to the interior heat exchanger of the building. Denoted by 406, this fan will circulate similarly air into the exterior heat exchanger, thus allowing heat to flow in and out from the cavity to the exterior part of the curtain wall. This arrangement will allow cooling of cavity heated by solar panels to interior or exterior or both. Denoted by 407, air flow from both heat exchangers will flow into the curtain wall cavity. 408 denotes the corrugated pipe, heat exchanger facing the exterior. 409 denotes the blown-up area and its location on said curtain wall.

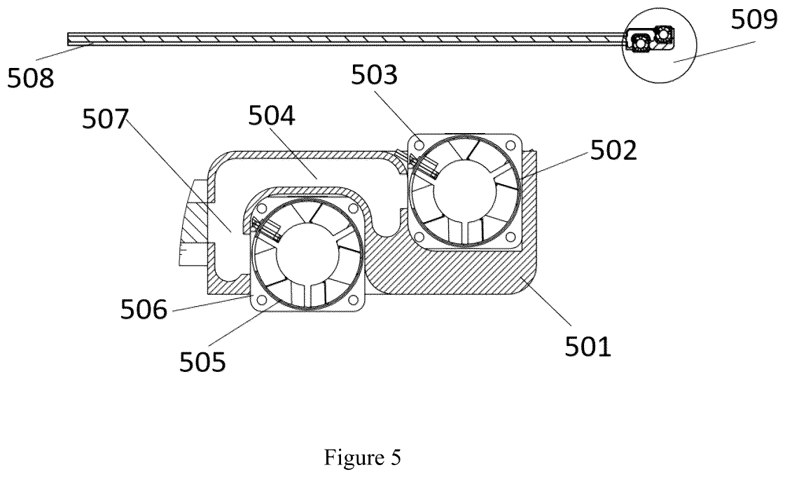

FIG. 5 is a cross-section similar to the cross-section direction of FIG. 4 but at a different location, at the edge of the curtain wall where air is sucked. 501 is an isolating shell and frame. 502 is the heat exchanger corrugated pipe. 503 are the fans of the corrugated pipe facing the interior, 504 is the special duct directing the airflow into the curtain wall cavity. 505 is the corrugated pipe facing the exterior of building. 506 is the fan activating the airflow for this heat exchanger. 507 is the area where both airflow is suctioned to external or internal heat exchanger according to the activated fans. 508 designates the curtain double wall assembly, and 509 shows the blown-up area of FIG. 5.

What is claimed is:

1. A solar panel assembly for curtain wall with built-in heat exchanger, comprising:
a non-structural isolating curtain wall with at least two panels, one of them facing towards the sunlight and has a built-in solar panel;
a heat exchanger kit equipped with fans circulating the air in between said panels;
electronic driver to control said fans;
batteries drawing their power from said solar panel; and
harnessing cables to conduct energy from said solar panel to building's electrical infrastructure.

2. A solar panel assembly according to claim 1, wherein the heat exchanger comprises of:
two heat exchangers, one facing the interior and the second facing the exterior;
fan means for each of said heat exchangers; and
control means activating the fans according to a microcontroller and
directing the heat exchanging to interior, to exterior or in a parallel mode.

3. A method, comprising:
a non-structural isolating curtain wall with at least two panels, one of them facing towards the sunlight and has a built-in solar panel;
a heat exchanger kit equipped with fans circulating the air in between said panels;
electronic driver to control said fans;
batteries drawing their power from said solar panel; and
harnessing cables to conduct energy from said solar panel to building's electrical infrastructure.

4. A method according to claim 3, comprising:
two heat exchangers, one facing the interior and the second facing the exterior;
fan means for each of said heat exchangers; and
control means activating the fans according to a microcontroller and
directing the heat exchanging to interior, to exterior or in a parallel mode.
